(19) United States
(12) Patent Application Publication
(10) Pub. No.: US 2006/0248675 A1
(43) Pub. Date: Nov. 9, 2006

(54) Vehicle windscreen wiper comprising an arm and an articulating connector

(75) Inventors: Pascal Vacher, Issoire (FR); Sébastien Rollet, Aigueperse (FR); Christophe Fely, Lamontgie (FR)

Correspondence Address: OSHA LIANG L.L.P., 1221 MCKINNEY STREET, SUITE 2800, HOUSTON, TX, 77010, US

(73) Assignee: VALEO SYSTEMES D'ESSUYAGE, La Verriere (FR)

(21) Appl. No.: 10/535,534

(22) PCT Filed: Nov. 19, 2003
(86) PCT No.: PCT/EP03/12942

§ 371 Date: May 2, 2006

(30) Foreign Application Priority Data
Nov. 19, 2002 (FR) 0214488

(51) Int. Cl. B60S 1/40; B60S 1/34

(52) U.S. Cl. 15/250.32; 15/250.351; 15/250.43

(57) ABSTRACT

A vehicle windscreen wiper comprising an arm and an articulation connector

The invention proposes a motor vehicle windscreen wiper which comprises a wiper blade (20) mounted so as to be articulated at the front longitudinal end (22a)
of a wiper arm (22) about a horizontal transverse axis (A) by means of a connector (24),
of the type in which the means of articulation of the connector (46a, 46b) with the end (22a) of the arm (22) comprise at least one pivot (56) with a transverse axis which extends transversely from a first associated support element (58) and which is able to be received in a complementary housing (62) in an associated second support element (60),
characterised in that the end (22a) of the arm (22) comprises means (52, 84) of longitudinal positioning of the connector distinct from the articulation means.

The invention proposes a motor vehicle windscreen wiper which comprises a compact vertical wiper blade which is mounted so as to be articulated at the end of a drive arm.

The invention proposes more particularly a motor vehicle wiper which comprises a wiper blade mounted so as to be articulated at the front longitudinal end of a wiper arm about a horizontal transverse axis by means of a connector,

of the type in which the connector comprises a roughly horizontal body whose bottom face carries hooks for fixing to a structural element of the blade which carries the wiper rubber,

of the type in which the top face of the connector body carries means of articulation with the end of the arm about the transverse articulation axis,

of the type in which the end of the arm comprises a web which extends substantially horizontally above the connector and which carries means of articulation of the connector about the transverse articulation axis,

of the type in which the means of articulation of the connector with the end of the arm comprise at least one pivot with a transverse axis coaxial with the transverse articulation axis, which extends transversely from a lateral face of a first associated support element belonging to the end of the arm or to the connector, and which is able to be received in a complementary housing produced in a second associated support element belonging to the connector or to the end of the arm, respectively,

of the type in which the first support element and/or the second support element comprise elastically deformable elements to allow the introduction of the pivot into the associated housing and cause the automatic radial locking of the pivot in the housing, and of the type in which the first support element and second support element are produced in one piece by moulding from plastics material with the arm or the connector respectively.

According to a design aimed at producing a wiper of low height, the articulated structure of the wiper blade which carries the wiping rubber or strip is omitted and it is the structural reinforcement elements which are associated with the flexible wiper strip in order to constitute the wiper blade proper.

The wiper blade is driven in alternating sweep on the window to be wiped by a conventional drive mechanism which comprises an arm driving the blade. Because of the complex shape of the window to be wiped, the blade is mounted so to be articulated about a transverse axis with respect to the drive arm, by means of an articulation connector.

According to a known embodiment, the connector is fixed to the blade by means of the structural elements, and is mounted so as to be articulated with respect to the arm about a transverse articulation axis.

Such a connector connecting a blade of low height to the end of a drive arm is described in the document WO-A-02.34592, and consists of a metallic plate shaped by bending so as to comprise means of fixing to the structural elements of the blade, means of articulation with the wiper arm, and means for guiding the connector with respect to the wiper arm about the articulation axis.

The end of the arm on which the connector is articulated comprises elastically deformable elements which permit relatively easy assembly of the connector with the end of the arm, also referred to as “snapping on”.

In order to fulfil the functions of fixing to the wiper blade and articulation with the end of the arm, various parts of the connector each have a specific form, which makes the production of the connector by bending relatively complex, and increases its manufacturing cost.

Another known wiper of the prior art is described in the document DE-A1-100.39.291. The arm comprises means of longitudinal positioning of the connector with respect to the arm. The means also have the function of articulating the arm with respect to the connector. However, including the two functions respectively of positioning and articulation in the same structure does not make it possible to optimise the configuration of each of the means separately.

The aim of the invention is to propose a wiper arm from which the connector is produced by production means having low cost and optimising both the positioning of the connector with respect to the arm and its articulation.

For this purpose, the invention proposes a wiper of the type described previously, characterised in that the end of the arm comprises means of longitudinal positioning of the connector distinct from the articulation means.

According to other characteristics of the invention:

the positioning means extend substantially transversely with respect to the longitudinal direction of the arm;

the positioning means comprise two vertical transverse ribs which connect two lateral cheeks of the end of the arm and which are distributed longitudinally with respect to the web of the arm so that the connector extends longitudinally between the transverse ribs when it is in position mounted between the cheeks of the end of the arm;

the connector comprises a portion in the form of a ramp which is able to cooperate with the bottom edge of a rib in order to position the connector longitudinally before the introduction of the pivot into the housing;

the connector and arm comprise means of limiting the magnitude of the pivoting of the blade, and of the connector, with respect to the arm, about the transverse articulation axis;

the connector comprises at least one rib, the top surface of which comes into abutment against the bottom face of the web of the end of the arm for an extreme angular position of the blade with respect to the arm;

at least one transverse rib of the arm extends vertically downwards so that the top face of the rubber comes into abutment against the bottom edge of the rib, for an extreme angular position of the blade with respect to the arm;

the second support element comprises an elastic clamp whose internal faces opposite the branches of the clamp each comprises a concave portion which partly delimits the housing and the branches of which are overall articulated about a transverse axis so as to separate to allow the introduction of the pivot into the housing;

the branches of the elastic clamp extend roughly vertically so that the pivot is able to be introduced vertically into the associated housing;

the second support element consists of a vertical longitudinal cheek which comprises a transverse orifice with a circular cross section delimiting the housing;

the cheek comprises a portion in the form of a ramp which extends from the free longitudinal edge of the cheek as far as the transverse orifice, on which the pivot rests when it is introduced into the housing, in order to cause the deformation of the elastically deformable elements;

the cheek is elastically deformable;

the free end of the pivot is bevelled and is able to cooperate with the portion of the cheek in the form of a ramp when the pivot is introduced into the housing;

the second support element comprises a vertical longitudinal lateral face with which there cooperates a facing vertical longitudinal face belonging to the first support element for the rotational guidance of the connector with respect to the front end of the arm;

the second support element comprises a vertical longitudinal lateral face with which there cooperates a facing vertical longitudinal guide face belonging to a rib for the rotational guidance of the connector with respect to the front end of the arm;

the second support element comprises at least one vertical longitudinal cheek, the lateral face of which opposite the first associated support element projects transversely with respect to the clamp in order to form a surface for guiding in rotation;

the connector comprises two vertical longitudinal cheeks distributed longitudinally on each side of the clamp, and the lateral faces of the cheeks, forming the guide surfaces, extend longitudinally on each side of the body of the connector;

the first support element and rib are distributed transversely on each side of the second support element;

the first support element is an element of the connector, and the second support element is a part of the end of the arm;

the rib is a part of the connector;

the first support element is an element of the end of the arm, and the second support element is a part of the connector;

the rib is a part of the end of the arm;

the connector and the end of the arm are each symmetrical with respect to the same vertical longitudinal mid-plane, so that the connector comprises two first support elements or two second support elements, and the end of the arm comprises two second support elements or two first support elements respectively;

the rib is arranged transversely between two second support elements.

Other characteristics and advantages of the invention will emerge from a reading of the following detailed description, for an understanding of which reference will be made to the accompanying figures, amongst which:

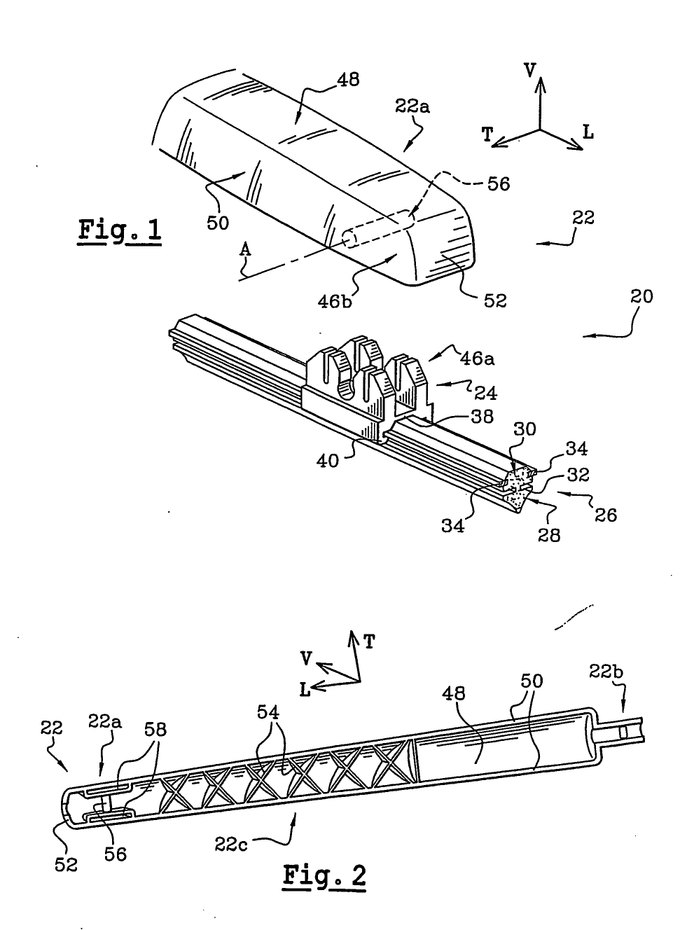

FIG. 1 is a schematic representation in exploded perspective of a wiper comprising an arm and a connector according to the invention;

FIG. 2 is a view from below of the drive arm depicted in FIG. 1;

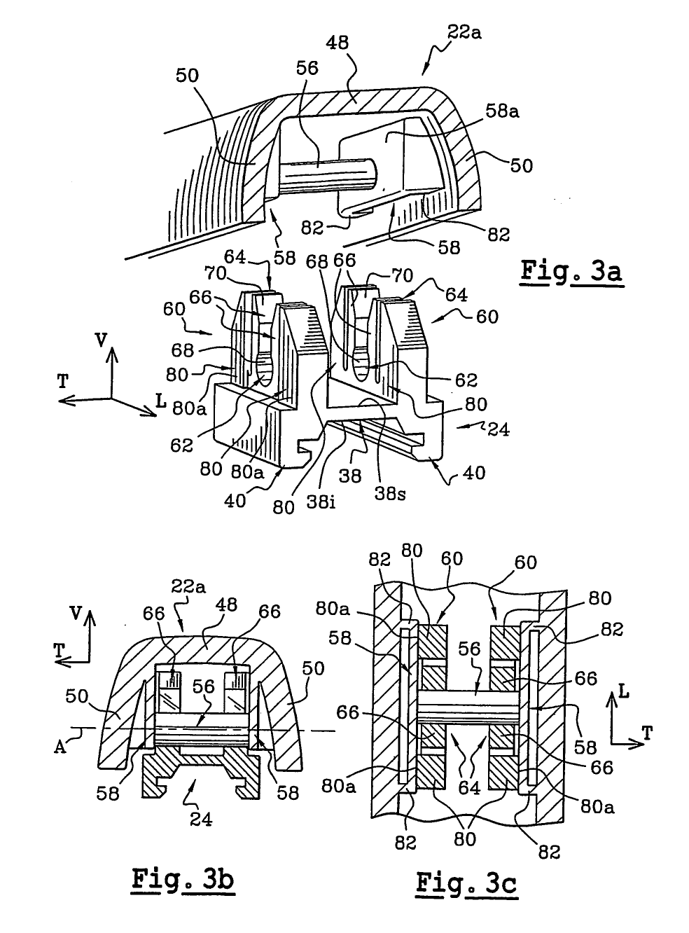

FIG. 3a is detail to a larger scale with cutaway of the connector and of the front end of the arm, which are depicted before they are assembled;

FIG. 3b is a section through a vertical transverse plane passing through the articulation axis of the connector and arm, depicted in the mounted position;

FIG. 3c is a section through a horizontal plane of FIG. 3b;

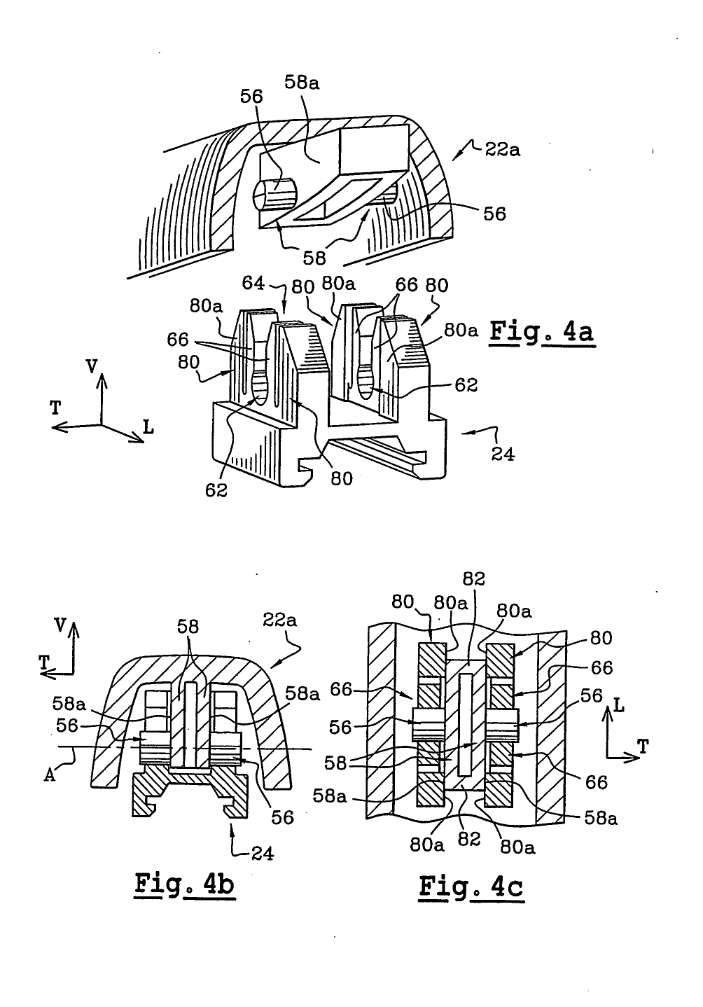

FIGS. 4a to 4c are views similar to views 3a to 3c, depicting a variant embodiment of the invention;

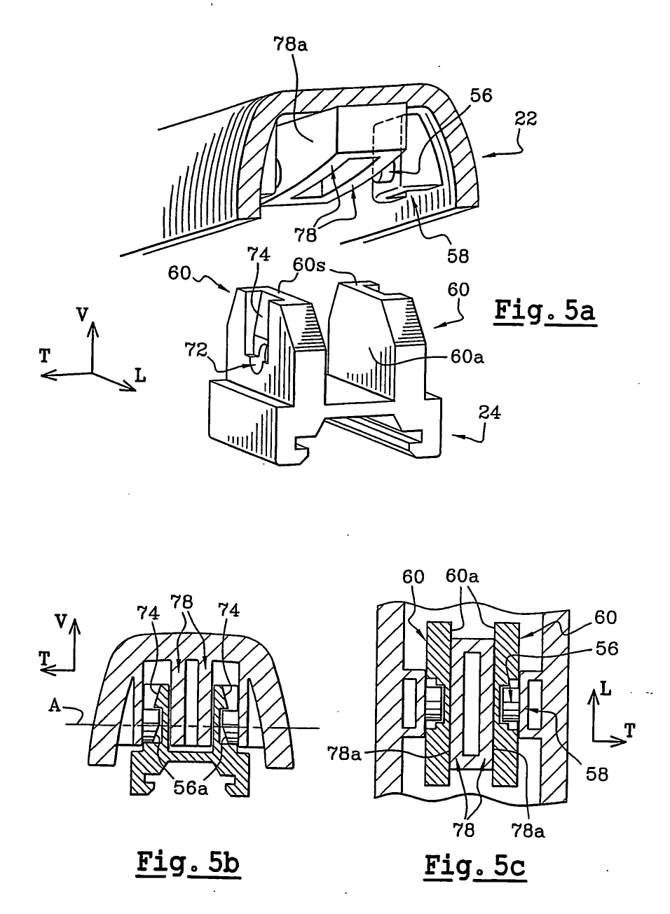

FIGS. 5a to 5c are views similar to views 3a to 3c, depicting a variant embodiment of the invention;

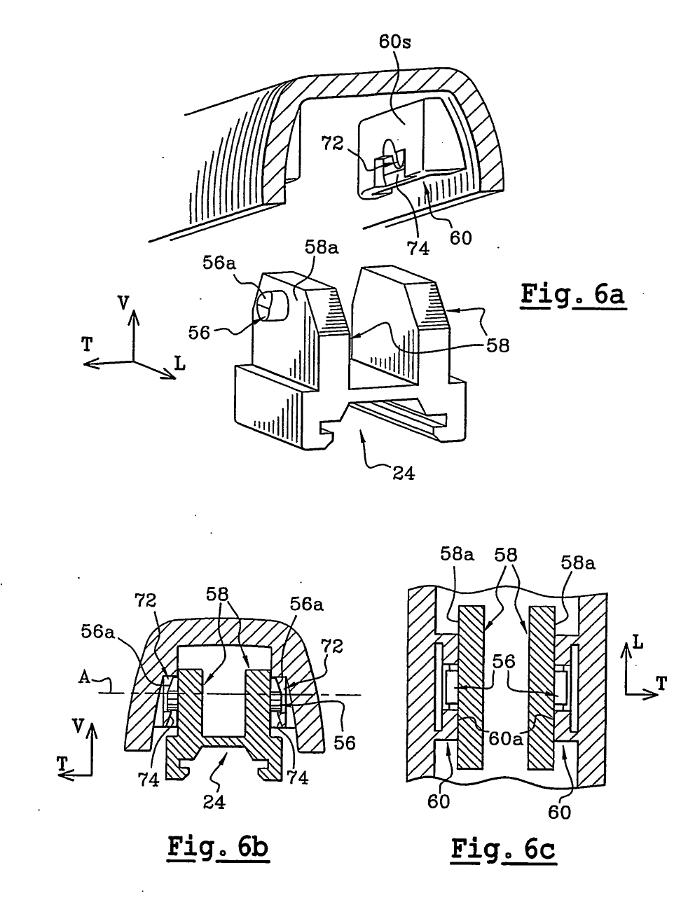

FIGS. 6a to 6c are views similar to views 3a to 3c, depicting another variant embodiment of the invention;

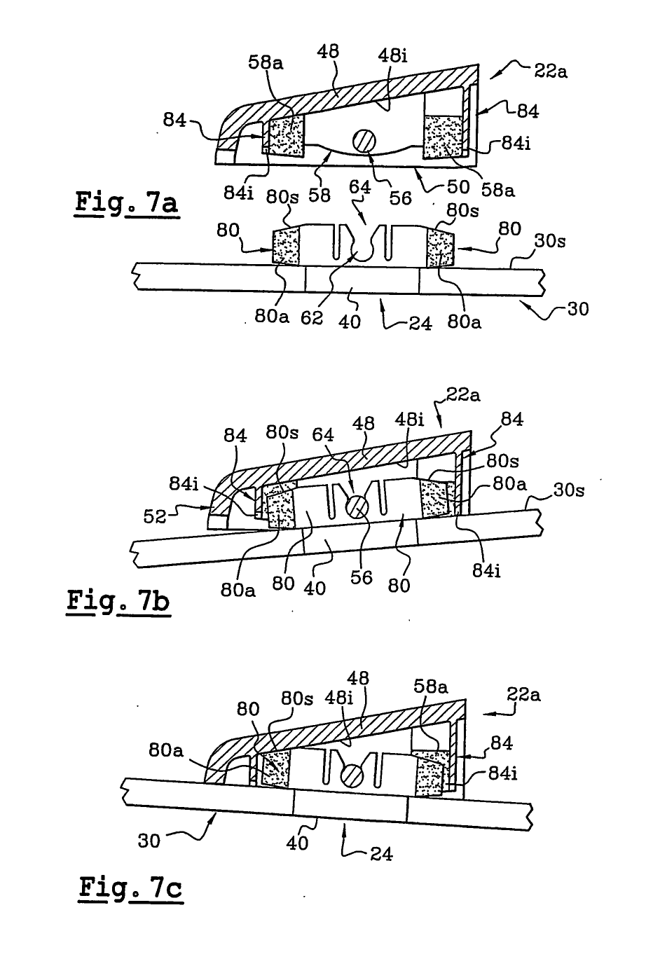

FIG. 7a is a section through a vertical longitudinal mid-plane of the front end of the arm and of the connector according to another variant embodiment of the invention; and

FIGS. 7b and 7c are views similar to that of FIG. 7a, depicting the means of limiting the magnitude of pivoting of the connector with respect to the end of the arm.

For the description of the invention, the orientations vertical, longitudinal and transverse will be adopted non-limitingly according to the reference frame V, L, T indicated in the figures.

The orientation from rear to front will also be adopted as being the longitudinal direction and from right to left as seen in FIG. 1.

The term “bottom” will be adopted to designate the part situated generally towards the window to be wiped.

The term “top” will also be adopted to designate the part situated generally opposite to the window to be wiped.

In the following description, identical, similar or analogous elements will be designated by the same reference numbers.

FIG. 1 depicts a wiper arm 20 intended to be mounted for rotation about an axis A transverse to the free front longitudinal end 22a of a wiper arm 22 by means of a connector 24.

The wiper blade 20 comprises a scraper 26 extending longitudinally, which consists in its bottom part of a blade 28 intended to rub against the window to be wiped, in its top part a fixing heel 30, and a strip 32 forming a hinge which connects the rubber 28 to the heel 30.

The wiper blade 20 also comprises stiffening vertebrae 34 which are each received in a complementary groove produced in a lateral edge of the heel 30.

The vertebrae 34 are designed so as to provide stiffness to the wiper blade 20, distributing the bearing force of the scraper 26 against the window to be wiped over its entire length.

As can be seen in more detail in particular in FIG. 3a, the connector 24 comprises a body 38 which consists overall of a planar plate which extends horizontally above the heel 30 of the scraper 26 and whose bottom face 38i carries means of fixing the connector 24 to the wiper blade 20.

These fixing means consist of two hooks 40 which extend vertically downwards along each lateral edge of the body 38, and the free bottom end of which is curved horizontally towards the inside of the connector 24 so that each hook 40 is able to receive the external longitudinal edge of a vertebra 34 in order to achieve the vertical and transverse positioning of the connector 24 with respect to the blade 20.

The longitudinal positioning of the connector 24 with respect to the blade 20 is achieved by means of a positioning protrusion (not shown) which extends transversely from an internal face of a hook 40 and which is able to be received in a complementary notch in the associated vertebra 34.

The body 38 of the connector 24 carries on its top face 38s means 46a of articulation about the transverse articulation axis A, which are able to cooperate with complementary articulation means 46b for the front longitudinal end 22a of the arm 22.

As can be seen in FIG. 2, the arm 22 extends roughly longitudinally, has a U-shaped vertical transverse section and comprises a horizontal top web 48 and two lateral cheeks 50 which extend vertically downwards from the lateral edges of the top web 48.

The rear longitudinal end 22b of the arm 22 is conformed so as to receive a head (not shown) for driving in rotation about a vertical axis.

As can be seen in more detail in FIG. 1, the front end 22a of the arm 22 is conformed so that, when it is connected to the connector 24, the latter is entirely covered by the front end 22a of the arm 22.

For this purpose, when the connector 24 is in the mounted position on the front end 22a of the arm 22, the web 48 of the front end 22a extends about the connector 24, the lateral cheeks 50 of the front end 22a of the arm 22 extend on each side of the connector 24, and at a distance from this. In addition, the top web 48 is extended forwards by a roughly vertical transverse cheek 52 which extends in front of the connector 24.

The arm 22 also comprises a certain number of reinforcement ribs 54 which connect the lateral cheeks 50 together and to the web 48, and which are distributed in the central part 22c of the arm 22 so as to procure sufficient stiffness for the arm 22.

Finally, the top web 48 of the front end 22a of the arm 22 carries on its bottom face 48i the articulation means 46b which cooperate with the articulation means 46a of the connector 24.

As depicted in FIGS. 3a to 6c, the means 46a, 46b of articulation of the connector 24 with the front end 22a of the arm 22 comprise at least one cylindrical pivot 56, with a circular cross section and a transverse axis merged with the transverse articulation axis A.

The pivot 56 is carried at least one of its transverse ends 56a by a first associated support element 58, so that the pivot 56 extends transversely from a lateral face 58a of the first support element 58.

The means 46a, 46b of articulation of the connector 24 with the front end 22a of the arm 22 also comprise at least one second support element 60 in which there is produced a complementary housing 62 of the pivot 56, for producing the rotational guidance of the connector 24 with respect to the front end 22a of the arm 22 about the transverse articulation axis A.

The first support element 58 and the second support element 60 are arranged so that the first support element 58 belongs either to the connector 24 or to the front end 22a of the arm 22, and so that the second support element 60 belongs either to the front end 22a of the arm 22 or to the connector 24 respectively.

Finally, the first support element 58 and/or the second support element 60 comprise elements which are able to deform elastically to allow the introduction of the pivot 56 into the associated housing 62, and to cause the automatic radial locking of the pivot 56 in the housing 62.

These elastically deformable elements allow an elastic fitting of the pivot 56 in the associated housing 62, and therefore easy assembly of the connector 24 with the arm 22, which is also referred to as “snapping on”.

The first support element 58 and the second support element 60 are produced in one piece from moulding from plastics material with the arm 22 or with the connector 24 respectively.

Plastic moulding is a process making it possible to produce an element with complex shapes at reduced cost and with reduced manufacturing constraints.

Since the connector 24 and the arm 22 each consist of a single element, assembly of the wiper is then simplified, the mounting of the connector 24 with the arm 22 taking place by elastic snapping on.

According to one embodiment of the invention, the connector 24 and the front end 22a of the arm 22 are each symmetrical with respect to the same vertical longitudinal mid-plane, so that they each comprise two first support elements 58 or second support elements 60 respectively.

In the following description, reference will be made to a single first support element 58, and to a single second support element 60, however it will be understood that this description also applies to the other first support element 58 and to the other second support element 60.

According to one embodiment of the invention, depicted in FIGS. 3a to 3c, the second support element 60 is an element of the connector 24, and therefore the first support element 58 is a front end element 22a of the arm 22.

The second support element 60 comprises an elastic clamp 64, the branches 66 of which extend vertically upwards from the lateral edge of the body 38 and are articulated about a transverse axis roughly situated below the transverse axis A of articulation on the blade 20 with respect to the arm 22.

The facing internal faces of the two branches 66 each comprise, close to the base of the associated branch 66, a concave portion 68 which partly delimits the housing 62, and, at the free top end of the associated branch 66, a portion in the form of a ramp 70 parallel to the transverse direction, on which the pivot 56 bears when it is introduced into the housing 62 in order to cause the separation of the associated branch 66.

Thus when the connector 24 is mounted with the wiper arm 22, the pivot 56 is introduced into the associated housing 62 by a vertical downward movement, and, given that the front end 22a of the arm 22 has roughly the form of a shell open at its bottom part, this type of movement appears natural for the person assembling the connector 24 with the arm 22.

According to this embodiment, the front end 22a of the arm 22 comprises a single pivot 56 which extends transversely between the lateral cheeks 50 of the arm 22 so that each end 56a of the pivot 56 is associated with one of the two support elements 60 and is received between the branches 66 of an elastic clamp 64.

According to this embodiment, the pivot 56 is connected to the arm 22 by means of two longitudinal flanges which extend vertically downwards from the bottom face 48i of the web 48, which each form a first support element 58, and the facing vertical longitudinal faces 58a of which carry the pivot 56.

The two longitudinal flanges are arranged transversely between the lateral cheeks 50 of the arm 22, and so as to extend on each side of the connector 24 when it is in position mounted on the arm 22.

Moreover, in order to increase rigidity between two flanges, the latter are connected at each of their longitudinal ends to the lateral cheeks 50 of the arm 22 by means of ribs 82.

According to another embodiment depicted in FIGS. 4a to 4b, the first support element 58 is arranged transversely close to the vertical longitudinal mid-plane of the front end 22a of the arm 22, so that the two flanges of the front end 22a of the arm 22 are arranged transversely between the two second support elements 60, and the associated pivot 56 extends transversely towards the outside of the arm 22 from the external lateral face 58a of the first support element 58.

According to a variant embodiment depicted in FIGS. 5a to 5c, the second support element 60 consists of a longitudinal cheek which extends vertically upwards from the top face 38s of the body 38 and which comprises a transverse orifice 72 which delimits the housing 62.

The introduction of the pivot 56 into the housing 62 is effected here also by a vertical downward movement of the arm 22 with respect to the connector 24. Because of this, the transverse cylindrical wall of the transverse orifice 72 prevents the introduction of the pivot 56 into the housing 62.

This is why the second support element 60 is elastically deformable and comprises a portion in the form of a ramp 74, inclined with respect to the vertical longitudinal plane of the second support element 60, and which extends vertically from the top longitudinal edge 60s of the second support element 60, as far as the cylindrical wall of the transverse orifice 72.

When it is introduced into the housing 62, the pivot 56 bears on the portion in the form of a ramp 74, causing the deformation of the second support element 60, principally of the portion in the form of a ramp 74, which retracts transversely for passage of the pivot 56.

In addition, the end 56a of the pivot 56 which bears on the portion in the form of a ramp 74 is bevelled in a complementary manner to the portion in the form of a ramp 74. This bevelled portion cooperates with the portion in the form of a ramp 74 in order to cause the deformation of the second support element 60.

According to this variant embodiment, the transverse orifice 72 is a blind hole which opens out at one of its transverse ends, here the external transverse end, with respect to the connector 24.

The pivot 56 is carried by the first support element 58 which is arranged transversely opposite the open end of the transverse orifice 72, that is to say here arranged transversely outside the connector 24, and the pivot 56 extends transversely from the face 58a of the first support element 58 which is facing the open end of the transverse orifice 72, that is to say here towards the inside of the arm 22.

FIGS. 6a to 6c depict another embodiment in which the first support element 58, and therefore the pivot 56, is an element of the connector 24, and the second support element 60 is an element of the front end 22a of the arm 22.

The structure of the first support element 58 and of the second support element 60, as well as of the pivot 56, is similar to that described for the previous embodiment, that is to say the second support element 60 consists of a vertical longitudinal cheek comprising a transverse orifice 72 delimiting the housing 62, and the first support element 58 consists of a vertical flange which carries the pivot 56 on one of its lateral faces 58a.

Naturally it will be understood that the second support element 60 can also comprise an elastic clamp 64 which extends vertically downwards from the web 48 of the front end 22a of the arm 22.

The chamber of the housing 62, which is complementary to that of the pivot 56, that is to say cylindrical with a circular cross section, allows rotational guidance about the transverse axis A of articulation of the connector 24 with respect to the front end 22a of the arm 22. However, this shape does not ensure locking in transverse movement of the connector 24 with respect to the arm 22.

Thus a transverse play may exist between the connector 24 and the arm 22, causing unpleasant noises and damaging the various elements of the wiper during operation thereof.

This is why, as depicted in FIGS. 4a to 4c and 6a to 6c, the first support element 58 and the second support element 60 each comprise a guide face, or “gadroon”, these faces being the vertical longitudinal lateral faces opposite the first and second support elements 58, 60, respectively, and cooperate for the rotational guidance of the connector 24 with respect to the front end 22a of the arm 22.

According to a variant of this aspect to the invention, depicted in FIGS. 5a to 5c, the vertical longitudinal face of the second support element 60 cooperates with a vertical longitudinal face 78a opposite a guide rib 78.

The guide rib 78 is produced in one piece with the first support element 58, that is to say with the arm 22 when the first support element 58 is produced in one piece with the arm 22, or is produced in one piece with the connector 24 when the first support element 58 is produced in one piece with the connector 24.

In addition, the guide rib 78 is positioned transversely on the arm 22 or connector 24 respectively, so that the guide 78 and the first support element 58 are distributed on each side of the second support element 60.

Thus, as can be seen in FIGS. 5a to 5c, when the first support element 58 is situated opposite the external face of the second support element 60, with respect to the connector 24, the guide rib 78 is situated opposite the internal face of the second support element 60, and, vice-versa, when the first support element 58 is situated opposite the internal face of the second support element the guide rib 78 is situated opposite the external face of the second support element.

Moreover, when the front end 22a of the arm 22 and the connector 24 are symmetrical with respect to the plane, when the guide rib 78 is situated opposite the internal face of the second support element 60, the front end 22a of the arm 22 or the connector 24 comprises a single guide rib 78, or the two ribs 78 are connected so as to form a single element, each of the lateral guide faces 78a of which bears against an internal vertical longitudinal lateral face of the second support element 60.

In the embodiment depicted in FIGS. 3a to 3c, the second support element 60 comprises an elastic clamp 68 which receives the pivot 56. When the guide rib 78 or the first support element 58 bears on a lateral face of the elastic clamp 64 the friction generated may then oppose the opening of the clamp 64 and therefore make the mounting of the connector 24 on the front end 22a of the arm 22 more difficult for the user.

In order to eliminate the contact between the elastic clamp 64 and the guide rib 78, or the first support element 58, the second support element 60 comprises two vertical longitudinal cheeks 80 distributed on each side of the elastic clamp 64 whose lateral face 80a opposite the first support element 58 or the guide rib forms the support face, and projects transversely with respect to the elastic clamp 64.

In addition, so that the rotational guidance of the connector 24 with respect to the front end 22a of the arm 22 is as effective as possible, that is to say in order to prevent the connector 24 pivoting with respect to the front end 22a of the arm 22 about a substantially vertical axis, the lateral faces 80a of the cheeks 80, which form guide surfaces, are separated significantly with respect to the housing 62 so that they extend on each side of the body 38 of the connector 24, preferably at a distance from it.

Since the front end 22a of the arm 22 is designed to entirely cover the connector 24 when the user wishes to mount the connector 24 with the front end 22a of the arm 22, and because of the position of the arm 22 with respect to the vehicle, it is relatively difficult for him to correctly position the connector 24 with respect to the front end 22a of the arm 22, and positioning then takes place “blind”, with more or less success on the part of the user.

The lateral cheeks 50 of the front end 22a of the arm 22 make it possible to position the connector 24 transversely with respect to the front end 22a of the arm 22. However, they do not make it possible to position it longitudinally.

This is why, according to one aspect of the invention, depicted in FIGS. 7a to 7c, the front end 22a of the arm 22 comprises two vertical transverse ribs 84 which extend vertically downwards from the bottom face 48i of the top web 48 and which connect the lateral cheeks 50.

The transverse ribs 84 are arranged longitudinally with respect to the top web 48 so that, when the connector 24 is in mounted position with the front end 22a of the arm 22, they extend on each side of the connector 24.

In addition, the connector 24 has vertical longitudinal cheeks 80 which extend vertically upwards from the body 38 of the connector 24, the top edge of which is conformed as a ramp.

Thus, when the pivot 56 is introduced into the housing 62, if the connector 24 is not correctly positioned longitudinally with respect to the front end 22a of the arm 22, the bottom edge 84i of a rib 84 comes into abutment against the top edge 80s of a cheek 80, signifying to the user the incorrect longitudinal positioning of the connector 24 and that it is necessary to move it longitudinally.

In addition, since the top edge 80s of each cheek 80 is conformed as a ramp, when the bottom edge 84i of a rib 84 bears against the top edge 80s of the associated cheek 80, a vertical force of insertion of the connector 24 on the part of the user causes a longitudinal movement of it towards the correct position with respect to the front end 22a of the arm 22 in which the pivot 56 can be introduced into the housing 62.

According to a variant embodiment (not shown), the longitudinal positioning of the connector 24 with respect to the front end 22a of the arm 22 is effected first by a rib 84 which is situated at the rear of the pivot 56 and secondly by the vertical transverse cheek 52 which extends the top web 48 forwards.

According to this variant the arm 22 has only one rib 84, which simplifies manufacture and reduces the weight of the arm 22.

When the user wishes to manipulate the blade 20, in particular in order to check the state of wear, he moves it away from the window to be wiped by making the arm 22 pivot with respect to the drive head. The blade 20 is then able to pivot freely with respect to the arm 22 about the axis A, and the magnitude of this pivoting is generally great, which is relatively a problem for the user.

This is why the connector 24 and the arm 22 comprise means for limiting the magnitude of pivoting of the connector 24 about the axis A.

As can be seen in FIG. 7b, the magnitude of pivoting in a first direction, here the trigonometric direction, is limited by the fact that the top face 30s of the heel 30 of the scraper 26 comes into abutment against the bottom edge 84i of a transverse rib 84, here the transverse rib 84 situated at the rear of the pivot 56.

As can be seen in FIG. 7c, the magnitude of the pivoting in the second direction, there the reverse trigonometric direction, is limited by the fact that the top edge 80s of the cheeks 80 of the connector 24, which are situated at the front of the housing 62, come into abutment against the bottom face 48i of the top web 48 of the arm 22.

According to one embodiment of the invention, the bottom edge 84i of the transverse rib 84 situated at the rear of the pivot 56 and the top edges 80s of the cheeks 80 situated at the front of the housing 62 extend vertically from the bottom face 48i of the top web 48 or from the top face 38s of the body 38 of the connector 24, respectively, so that the magnitude of pivoting of the blade 20 with respect to the arm 22 in one direction or the other is of a predetermined angle. This predetermined angle makes it possible to preserve an abutment of the arm 22 on the window at each point thereon, and is preferably equal to 10°.

According to one embodiment of the invention, the connector 24 also has symmetry with respect to a transverse vertical mid-plane so that the cheeks 80, and more particularly their top edges 80s, are symmetrical with respect to this mid-plane.

This symmetry enables the user to avoid having to check the orientation of the connector 24 with respect to the arm 22 at the time of mounting, and hence a saving in time and a gain in simplicity of the mounting for the user, but also the time of first assembly in the factory.

Here the limitation of the magnitude of the pivoting of the blade 20 with respect to the arm 22 is achieved by different means according to the direction of pivoting. However, it will be understood that the means for limiting the magnitude of pivoting may be identical for the two directions of pivoting or reversed for the two directions of pivoting, without departing from the scope of the invention.

In addition, the limitation of the magnitude of pivoting of the blade 20 with respect to the arm 22 in the reverse trigonometric direction can be achieved either by means of a transverse rib 84 or by the vertical transverse cheek 52 which extends the top web 48 forwards.

A connector and drive arm which are each produced in a single piece by plastic moulding first reduce the manufacturing cost of each of these components and secondly reduce the assembly time for the wiper mechanism.

What is claimed is:

1. A motor vehicle wiper which comprises a wiper blade mounted so as to be articulated at a front longitudinal end of a wiper arm about a transverse articulation axis by means of a connector,
wherein the connector comprises a connector body that is roughly horizontal and whose bottom face carries hooks for fixing to a structural element of the wiper blade which carries a wiper rubber of the wiper blade,
wherein a top face of the connector body carries means of articulation with an end of the wiper arm about the transverse articulation axis,
wherein the end of the wiper arm comprises a web which extends substantially horizontally above the connector and which carries the means of articulation of the connector about the transverse articulation axis,
wherein the means of articulation of the connector with the end of the wiper arm comprise at least one pivot with a transverse axis coaxial with the transverse articulation axis, which extends transversely from a lateral face of a first associated support element belonging to one of the end of the wiper arm and the connector, and which is able to be received in a complementary housing produced in a second associated support element belonging to the other of the connector and the end of the wiper arm,
wherein at least one of the first support element and the second support element comprises elastically deformable elements to allow the introduction of the pivot into the complimentary housing and cause the automatic radial locking of the pivot in the complimentary housing,
wherein the first support element is produced in one piece by moulding from plastics material with one of the wiper arm and the connector and the second support element is produced in one piece by moulding from plastics material with the other of the wiper arm and the connector, and
wherein the end of the wiper arm comprises means for the longitudinal positioning of the connector distinct from the articulation means.

2. The motor vehicle wiper according to claim 1, wherein the longitudinal positioning means extend substantially transversely with respect to the longitudinal direction of the wiper arm.

3. The motor vehicle wiper according to claim 1, wherein the longitudinal positioning means comprise two vertical transverse ribs which connect two lateral cheeks of the end of the wiper arm and which are distributed longitudinally with respect to the web of the wiper arm so that the connector extends longitudinally between the transverse ribs when the connector is in position mounted between the cheeks of the end of the wiper arm.

4. The motor vehicle wiper according to claim 3, wherein the connector comprises a ramp portion which is able to cooperate with a bottom edge of a rib in order to position the connector longitudinally before the introduction of the pivot into the complimentary housing.

5. The motor vehicle wiper according to claim 1, wherein the connector and wiper arm comprise means of limiting the magnitude of the pivoting of the wiper blade, and of the connector, with respect to the wiper arm, about the transverse articulation axis.

6. The motor vehicle wiper according to claim 5, wherein the connector comprises at least one rib, the top surface of which comes into abutment against a bottom face of the web of the end of the wiper arm for an extreme angular position of the wiper blade with respect to the wiper arm.

7. The motor vehicle wiper according to claim 5, wherein at least one transverse rib of the wiper arm extends vertically downwards so that a top face of the wiper rubber comes into abutment against a bottom edge of the rib, for an extreme angular position of the wiper blade with respect to the wiper arm.

8. The motor vehicle wiper according to claim 1, wherein the second support element comprises an elastic clamp whose internal faces opposite branches of the elastic clamp each comprises a concave portion which partly delimits the complimentary housing and the branches of which are overall articulated about a transverse axis so as to separate to allow the introduction of the pivot into the complimentary housing.

9. The motor vehicle wiper according to claim 8, wherein the branches of the elastic clamp extend roughly vertically so that the pivot is able to be introduced vertically into the complimentary associated housing.

10. The motor vehicle wiper according to any one of claim 1, wherein the second support element consists of a vertical longitudinal cheek which comprises a transverse orifice with a circular cross section delimiting the complimentary housing.

11. The motor vehicle wiper according to claim 10, wherein the cheek comprises a ramp portion which extends from a free longitudinal edge of the cheek as far as the transverse orifice, on which the pivot rests when introduced into the complimentary housing, to deform the elastically deformable elements.

12. The motor vehicle wiper according to claim 11, wherein the cheek is elastically deformable.

13. The motor vehicle wiper according to claim 11, wherein a free end of the pivot is bevelled and is able to cooperate with the ramp portion of the cheek when the pivot is introduced into the complimentary housing.

14. The motor vehicle wiper according to claim 1, wherein the second support element comprises a vertical longitudinal lateral face with which there cooperates a facing vertical longitudinal face belonging to the first support element for the rotational guidance of the connector with respect to the front end of the wiper arm.

15. The motor vehicle wiper according to claim 1, wherein the second support element comprises a vertical longitudinal lateral face that cooperates with a facing vertical longitudinal guide face belonging to a rib for the rotational guidance of the connector with respect to a front end of the wiper arm.

16. The motor vehicle wiper according to claim 14, wherein the second support element comprises an elastic clamp whose internal faces opposite branches of the elastic clamp each comprises a concave portion which partly delimits the complimentary housing and the branches of which are overall articulated about a transverse axis so as to separate to allow the introduction of the pivot into the complimentary housing, and wherein the second support element comprises at least one vertical longitudinal cheek, a lateral face of which opposite the first support element projects transversely with respect to the elastic clamp in order to form a surface for guiding in rotation.

17. The motor vehicle wiper according to claim 16, wherein the connector comprises two vertical longitudinal cheeks distributed longitudinally on each side of the elastic clamp, and wherein the lateral faces of the cheeks form guide surfaces that extend longitudinally on each side of the connector body.

18. The motor vehicle wiper according to claim 16, wherein the first support element and the rib are distributed transversely on each side of the second support element.

19. The motor vehicle wiper according to claim 1, wherein the first support element is an element of the connector, and in that the second support element is a part of the end of the wiper arm.

20. The motor vehicle wiper according to claim 19, wherein the second support element comprises a vertical longitudinal lateral face that cooperates with a facing vertical longitudinal guide face of a rib for the rotational guidance of the connector with respect to a front end of the wiper arm, and wherein the rib is a part of the connector.

21. The motor vehicle wiper according to claim 1, wherein the first support element is an element of the end of the wiper arm, and the second support element is a part of the connector.

22. The motor vehicle wiper according to claim 21, wherein the second support element comprises a vertical longitudinal lateral face that cooperates with a facing vertical longitudinal guide face of a rib for the rotational guidance of the connector with respect to a front end of the wiper arm, and wherein the rib is a part of the end of the wiper arm.

23. The motor vehicle wiper according to claim 1, wherein the connector and the end of the wiper arm are each symmetrical with respect to the same vertical longitudinal mid-plane, so that the connector comprises one of two first support elements and two second support elements, and the end of the wiper arm comprises the other of the two second support elements and the two first support elements.

24. The motor vehicle wiper according to claim 23, wherein the second support element comprises a vertical longitudinal lateral face that cooperates with a facing vertical longitudinal guide face of a rib for the rotational guidance of the connector with respect to a front end of the wiper arm, wherein the rib is a part of the connector, and wherein the rib is arranged transversely between two second support elements.
